(19) United States
(12) Patent Application Publication
(10) Pub. No.: US 2010/0089678 A1
(43) Pub. Date: Apr. 15, 2010

(54) MULTI WHEELED SINGLE TRACK VEHICLE

(76) Inventor: Jonathan Mark Parsons, Bristol (GB)

Correspondence Address: Jonathan Mark Parsons, 5 Gloucester Road, Bristol, BS32 4HD, GB

(21) Appl. No.: 12/449,107

(22) PCT Filed: Jan. 15, 2008
(86) PCT No.: PCT/GB2008/000110

§ 371 Date: Jul. 23, 2009

(30) Foreign Application Priority Data
Feb. 1, 2007 (GB) 0701890.6
Feb. 10, 2007 (GB) 0702657.8
Apr. 17, 2007 (GB) 0707354.7

(51) Int. Cl. B62K 5/02

(52) U.S. Cl. 180/211

(57) ABSTRACT

A multi wheeled single track vehicle comprising of three or more wheels in a line, where two or more wheels are steered by an amount to enable the vehicle to follow a single track. Two or more wheels of the wheels are driven by a transmission comprising a chain and sprocket for drive from the engine to one wheel and another chain and sprocket for drive from one wheel to another. Suspension is provided for each wheel by a pair of equal, or near equal length of swinging arms, one above the other, (upper swinging arm and lower swinging arm) where both arms are positioned with the wheel end pivot axis above the wheel axle, and the motorcycle frame pivot axis above the final drive engine sprocket axis, with a spring damper (shock absorber) positioned between upper and lower swinging arms and a wheel axle support strut supporting the wheel axle.

### TECHNICAL FIELD

This invention relates to a Multi Wheeled Single Track Vehicle with steering, transmission, brake and suspension system for three or more the wheels, where the wheels are in a line to follow a single track. The steering, transmission, brake and suspension system described in this invention may also be used as a complete system or in part, in other types of vehicle.

In order for the Multi Wheeled Single Track Vehicle to function in a similar fashion to a motorcycle with the advantage of improved traction and stability its design incorporates steering, transmission, brake and a suspension system.

The steering design in this invention has similarities to conventional motorcycle steering systems where the wheel is steered about a steering axis and that axis is kept at a near constant caster angle, but in this invention provision is made for the wheel to be driven by chain and sprocket as well as steered. The steering system may be used on the front or rear wheel of a two wheel motorcycle or on any of the middle wheels on an in-line multi wheeled motorcycle, or on any wheel of other types of vehicle. Other types of wheel drive may be used for example belt, gears, shaft, electric or hydraulic.

The suspension design has similarities to the suspension system used for a conventional motorcycle's rear wheel, with a swinging arm and spring damper, where the swinging arm is used to locate the rear wheel in relation to the rest of the motorcycle whilst allowing the wheel to move up and down against the spring damper.

The suspension system in this invention comprises of a pair of swinging arms (an upper and lower swinging arm), one above the other and a spring damper (shock absorber) acting between the swinging arms, where one end of the swinging arm pair attaches to the motorcycle frame and the other attaches to a strut which locates the wheel. Pairs of swinging arms complete with spring damper and wheel support strut can be used for front or rear wheels, or to connect one wheel to another for applications where two or more wheels are connected in a line.

### BACKGROUND ART

Motorcycles usually have only two wheels in a line, steering at the front, powered drive to the rear through a transmission, brakes on both wheels and separate suspension for each wheel. In order to increase the motorcycle's grip onto the road an increase in tyre to road contact is required which can be achieved by increasing tyre width or diameter or adding additional wheels. Increasing tyre width or diameter is only possible to a certain degree. Incorporating more wheels is possible, but unless these wheels are in a line the width of the vehicle increases and the ability to lean the vehicle when cornering is restricted. Incorporating additional wheels with their own drive and brake provides increased traction for acceleration and braking. However designs for motorcycles with more than two wheels in a line are not common, because in order to go around a corner more than one wheel is required to be steered and for travelling over bumps each wheel must be capable of going over the bump separately. Providing steering to more than one wheel e.g. front and rear steering can improve manoeuvrability, cornering and stability. Therefore the desired layout to increase traction, manoeuvrability, cornering and stability incorporates more than one wheel being steered in a single track, transmission to more than one wheel, braking and independent suspension for all wheels.

Nearly all current motorcycles have rear suspension systems that use a swinging arm to locate the rear wheel and allow it to pivot about the motorcycle frame against a spring damper. However this layout of suspension system is a compromise between suspension dynamics, transmission geometry and geometric packaging and does not allow additional wheel steering in a multi-wheel configuration. In order to achieve the desired multi wheel single track vehicle layout the following problems with conventional motorcycles need to be overcome:

Problem “A”—Concerning the steering axis and chain drive movement during suspension movement. For the suspension to operate the wheel moves upwards rotating about the swinging arm's pivot point in the frame and if the steering is mounted to the end of the swinging arm then the steering caster angle will change when the swinging arm moves.
Problem “B”—Concerning the chain drive combined with steering. The chain drive system must remain parallel to the engine drive (which is on the vehicle's horizontal axis), whilst the steered wheel driven by the chain must be allowed to turn about a steering axis.
Problem “C”—Concerning chain tension changing as the swinging arm moves. For nearly all current motorcycles the transmission chain tension changes as the wheel moves up and down due to the final drive engine sprocket being positioned ahead of the swinging arm to frame pivot. This results in a shorter movement arc of the swinging arm compared to the desired arc between engine and wheel sprockets.
Problem “D”—Concerning providing a guard for the chain. For nearly all current motorcycles part of the chain runs above the swinging arm making it necessary to incorporate a chain guard above the swinging arm.
Problem “E”—For current motorcycles with a short wheelbase motorcycles, particularly those with wide tyres, the wheel cannot be positioned close to the engine or swinging arm pivot in the frame, because the swinging arm narrows down toward the pivot in the frame. Some motorcycles use swinging arms with one side member shaped as a “̂” to provide clearance for the exhaust pipe, while on the chain side the arm passes in a conventional manner between the upper and lower sections of the chain, which prevents the wheel from being moved forwards. For multi wheel single track vehicles where the wheel is required to steer Problem “E” is worse as there must be additional clearance between the tyre side wall and the swinging arm.
Problem “F”—For current motorcycles there is a limited space available for the spring damper, while providing the correct ratio of spring movement compared to the movement of the wheel. For multi wheel single track vehicles this problem is worse.

### DISCLOSURE OF INVENTION

According to the present invention, there is provided a multi wheeled single track vehicle comprising of three or more wheels in a line, where two or more wheels are steered by an amount to enable the vehicle to follow a single track. Two or more of the wheels are driven by a transmission comprising a chain and sprocket for drive from the engine to one wheel and another chain and sprocket for drive from one wheel to another. Suspension is provided for each wheel by a pair of equal, or near equal length of swinging arms, one above the other, (upper swinging arm and lower swinging arm) where both arms are positioned with the wheel end pivot axis above the wheel axle, and the motorcycle frame pivot axis above the final drive engine sprocket's rotational axis, with a spring damper (shock absorber) positioned between upper and lower swinging arms and a wheel axle support strut supporting the wheel axle.

For a multi wheeled single track vehicle with an in-line three wheel layout, to enable the vehicle to follow a single track one of the wheels is not steered while the other wheels are steered and if the rear wheel is steered the turning direction is in reverse to the front wheel, i.e. the rear counter steers to the front. Steering and suspension for the front wheel may be similar to the other wheels and may be driven, or follow the conventional motorcycle telescopic fork steering suspension arrangement without drive. The steering of any of the steered wheels may be by wheel hub steering or other available steering mechanisms. The steering axis is located in the desired position and caster angle, by the upper and lower swinging arms. One end of the upper swinging arm and lower swinging arm are mounted by pivot joints on the frame and can pivot up and down whilst being restrained from lateral or torsional movement.

The other end (wheel end) of the upper swinging arm is mounted by a spherical bearing to a wheel bearing housing steering strut. The spherical bearing may be replaced by other joint types allowing rotation movement along two axis, one axis for steering, the other for suspension. The other end (wheel end) of the lower swinging arm is mounted by an axial and thrust load bearing to a sprocket drive bearing housing. This axial and thrust load bearing may be replaced by other joint types allowing rotation about one axis only for suspension movement. The sprocket drive bearing housing and the wheel bearing housing steering strut are joined by an axial and thrust load bearing positioned to allow rotation of the wheel bearing housing steering strut about the steering axis. This axial and thrust load bearing may be replaced by other joint types allowing rotation about one axis only for steering movement. The sprocket drive bearing housing is joined to the wheel bearing housing steering strut, which act together as a steering strut and keep the upper and lower swinging arm and wheel axle positioned for suspension and steering movement. The upper and lower swinging arms move about the frame in a parallelogram shape and allow the wheel to move up and down whilst maintaining a constants steering caster angle (caster angle being the angle between the vehicle horizontal centreline and this steering strut), thus solving problem “A”.

Steering control is achieved by a rod and/or cable mechanism connected at one end to the handlebar or other part of the front steering system, which provides a push and/or pulling action on the wheel bearing housing steering strut to steer the wheels. The force applied by the cable causes the wheel bearing housing steering strut to rotate about the spherical bearing attached to the upper swinging arm and the pivot joint with the sprocket bearing housing.

The spherical bearing and wheel bearing housing steering strut to sprocket bearing housing pivot are on the steering axis which in turn is in the mid vertical plane of the motorcycle and wheel. Other methods of applying a steering force on the wheel bearing housing steering strut can be used e.g. hydraulics, pneumatics or electric drive. For two or more wheel steering a connection can be made between each wheels' steering systems. The amount of steering force applied to wheel bearing housing steering strut can be proportional to the steering effort applied by rider or controlled by a computer.

For the transmission the chain drive sprocket is mounted on a drive shaft which can rotate in bearings in the sprocket drive bearing housing. The wheel is mounted on a separate drive shaft which can rotate in bearings in the wheel bearing housing steering strut. The two shafts are connected by a Constant Velocity (CV) joint. The lower swinging arm, swinging arm to sprocket drive bearing housing pivot and sprocket drive bearing housing to wheel bearing housing steering strut pivot are positioned above the sprocket drive axis, thus allowing room for the CV joint. The chain drive drives a sprocket which in turn drives a CV which drives the rear wheel. The CV joint allows drive even when the wheel is steered and there is an angle between the sprocket's rotational axis and the wheel's rotational axis, thus overcoming Problem “B”. The CV joint may be replaced by other joint types allowing power transmission through two shafts where there is a variable angle between the rotational axis of one shaft to the rotational axis of the other shaft.

For the suspension, movement of the wheels is controlled by the upper swinging arm, lower swinging arm, wheel axle/drive sprocket support strut and a spring damper (shock absorber) positioned between these swinging arms. The wheel axle is located on the wheel support strut rather than directly on the swinging arm.

Both of the swinging arms are at one end attached to the motorcycle frame by pivot joints and at their other end attached to the wheel axle support strut by pivot joints. The length between the axis of the pivot joints at the ends of one swinging arm is the same or nearly the same as the length between the axis of the pivot joints at the ends of the other swinging arm, which is in turn the same or nearly the same as the distance between the engine drive sprocket's rotational axis and the wheel drive sprocket's rotational axis. The distance between the two swinging arms' pivot axis on the motorcycle frame is the same or nearly the same as the distance between the two swinging arms' pivot axis on the wheel axle/drive sprocket support strut. The distance between the lower swinging arm's pivot axis on the wheel axle/drive sprocket support strut to the wheel drive sprocket's rotational axis is the same or nearly the same as the distance between the lower swinging arm's pivot axis on the motorcycle frame to the engine drive sprocket's rotational axis. Both swinging arms are positioned with their wheel axle/drive sprocket support strut pivot axis above the wheel axle, and the motorcycle frame pivot axis above the final drive engine sprocket axis. The wheel axle/drive sprocket support strut has pivot points for both upper and lower swinging arm and provides support for the wheel axle.

The swinging arm pair allows the wheel to move up and down following the same or similar arc to an arc traced out from the engine drive sprocket axis to the wheel drive sprocket axis, thus solving Problem “C”.

The lower swinging arm is above the chain making it unnecessary for a separate chain guard thus solving Problem D. The lower swinging arm's side member is set to at an angle to the line between each end pivot points as it passes the wheel tyre to increase the clearance between the swinging arm members and the tyre. The “̂” shape in the lower swinging arm allows the upwards angled side member of the swinging arm from the frame pivot point upwards to incorporate bracing to strengthen it. This portion is above the circumference of the wheel, whilst the downwards angled part of the side member crosses the wheel circumference to the wheel axle support strut pivot. The “̂” shape of the lower swinging arm combined with its pivot being above the engine final drive sprocket, allows the wheel to be placed close to the rear of the engine and engine final drive sprocket, thus solving Problem “E”. The lower swinging arm has a suspension spring damper mounting point at the top of “̂” shape positioned at or near the motorcycle vertical axis. The upper swinging arm has a lug close to the pivot point allowing the spring damper to be mounted in a near horizontal position between the upper and lower swinging arm thus providing a solution to Problem “F”. Alternative arrangements are with the spring damper mounting being at other positions on the lower swinging arm or on the top swinging arm or on the frame.

The suspension linkages can be repositioned to allow changes in the rate of spring compression for any of the wheels. The spring dampers operate in series and can have different spring rates. The rear spring can be set with a lower spring rate.

The upper and/or lower swinging arms may be positioned to one side of the wheel, or made with a fork to be positioned with the wheel between the sides of the swinging arm fork. An alternative arrangement may be used where the upper and lower swinging arm pivot point are on either side, or both below, the final drive engine sprocket and wheel axle sprocket. For a multi-wheel vehicle the swinging arms may be between wheels, with separate support steering struts for each wheel. Pairs of swinging arms complete with spring damper and wheel support steering strut can be used for front or rear wheels, or to connect one wheel to another for applications where two or more wheels are connected in a line. The wheel may be braked with a brake calliper fixed to the wheel bearing housing steering strut and a disc brake fitted to a to the wheel axle. Provision is made for individual wheels to be braked by their own brakes, alternatively a single brake can be used on one wheel, where the chain transmission provides braking for the other wheels. An engine, or engines, to propel the vehicle may be located between the front and second wheel, above or to the side of the second or in one or more of the wheels.

### BRIEF DESCRIPTION OF DRAWINGS & BEST MODE FOR CARRYING OUT THE INVENTION

A specific embodiment of the invention will now be described by way of example with reference to the accompanying drawing in which:

FIG. 1 shows a view on the side of the vehicle upper and lower swinging arms and steering strut arrangement. Referring to the vehicle steering system comprises a lower swinging arm 1, an upper swinging arm 2, a sprocket drive bearing housing 3 and a wheel bearing housing steering strut 4, a wheel drive sprocket 5, wheel 6, a chain 7, pivot points eg 8, control cable 9, a sprocket shaft 10, a spring damper 17, an engine driven sprocket 18 and a vehicle frame 19. The wheel 6 can move upwards whilst the upper and lower swinging arms 1 and 2 rotate about their pivots attached to the frame 19 (shown in part). The sprocket drive bearing housing 3 is connected to the lower swinging arm 1 at pivot 8 and the wheel bearing housing steering strut 4 is connected to the upper swinging arm 2 at a spherical bearing. As the swinging arms rotate Axis “H”, “H1” and “H2” rotate together in a parallelogram movement with the wheel bearing housing steering strut 4 and sprocket drive bearing housing 3 moving to maintain the Axis “V1” at a constant angle to the horizontal axis of the vehicle. Two control cables 9 are anchored to the upper swinging arm 2, one either side. The control cables 9 provide pull or push actuation to the wheel bearing housing steering strut 4 to cause it to steer the wheel. The distance between the sprockets' 5 and 18 is the same or similar to the distance between the lower swinging arm's 1 front and rear pivot axis, which is in turn the same or similar to the distance between the upper swinging arm's 2 front and rear pivot axis.

The distance between the lower swinging arm's 1 frame mounted pivot axis to the sprocket 18 axis is at an equal or near equal to the distance between the lower swinging arm's 1 rear pivot axis and the sprocket 5's axis. This enables the wheel to move up and down without changing the tension in the chain. The lower swing arm 1 has a pivot attachment to the spring damper 17, thus when the wheel 6 hits a bump the wheel bearing housing steering strut 4 and sprocket drive bearing housing moves up which in turn causes the lower swinging arm 1 to rotate about its pivot in the frame 10 and compress the spring damper's 17 spring. The spring damper can be mounted between the frame and lower swinging arms, or between the upper and lower swinging arms. The “̂” shape in the lower swinging arm 1 allows the portion of the swinging arm from the frame pivot point upwards to incorporate bracing to strengthened it as this portion is above the circumference of the wheel, whilst the downwards portion crosses the wheel circumference to the wheel axle support strut pivot. The lower swinging arm's 1 “̂” shape combined with it's pivot point being above the engine final drive sprocket 18 enables the wheel to be positioned close to the rear of the engine and engine's final drive sprocket 18.

FIG. 2 shows a view on the end of the vehicle with the wheel removed. Axis “B”, “C” and “D” move up or down together controlled by lower swinging arm 1 and upper swinging arm 2. The lower swinging arm 1 and upper swinging arm 2 can move up and down Axis “A”, while wheel bearing housing steering strut 4 can move up and down Axis “A” and rotate around Axis “A”.

Rotation of wheel bearing housing steering strut 4 is guided by a spherical bearing 11 which is mounted in the upper swinging arm 2 and a pivot bearing providing axial and thrust load restraint, between the wheel bearing housing steering strut 4 and sprocket drive bearing housing 3. A CV 13 is connected to sprocket shaft 10 and wheel shaft 16 and is positioned on the intersection of Axis “A” and Axis “B” and allows transmission between sprocket 5 and wheel mounting 15 even when the wheel bearing housing steering strut 4 is rotated about Axis “A”. Item 12 fastens the spherical bearing 11 to the wheel bearing housing steering strut 4. Braking is by a disc 14 mounted to the wheel mounting 15 and a brake calliper (not shown) can be mounted to the wheel bearing housing steering strut 4. The wheel bearing housing steering strut 4 has wheel bearing inserted into it. The sprocket drive bearing housing 3 has axial load bearing inserted into it.

FIG. 3 shows a view on the top of the vehicle. If cable 9 is pushed or pulled then the wheel bearing housing steering strut 4 is rotated about the spherical bearing 9 and wheel 6 is steered. While the wheel is steered the sprocket drive bearing housing 3 remains in line with Axis “H”.

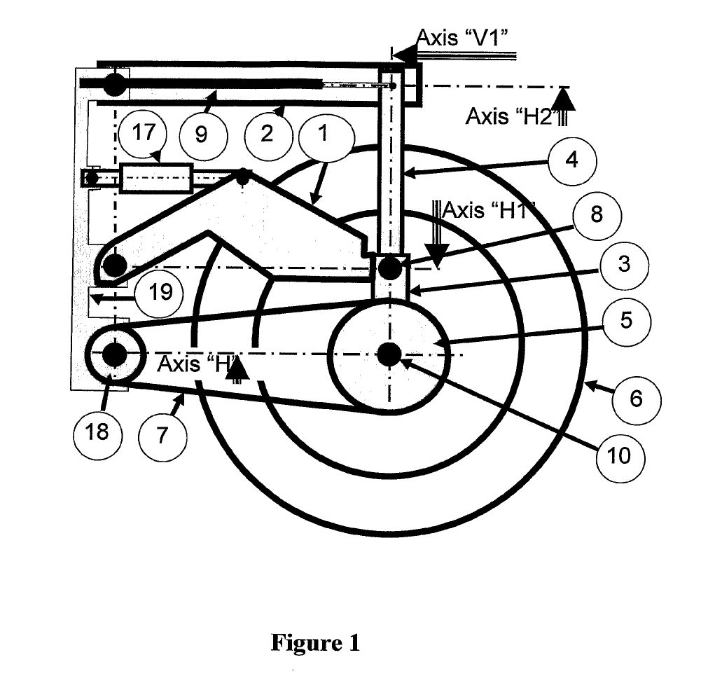

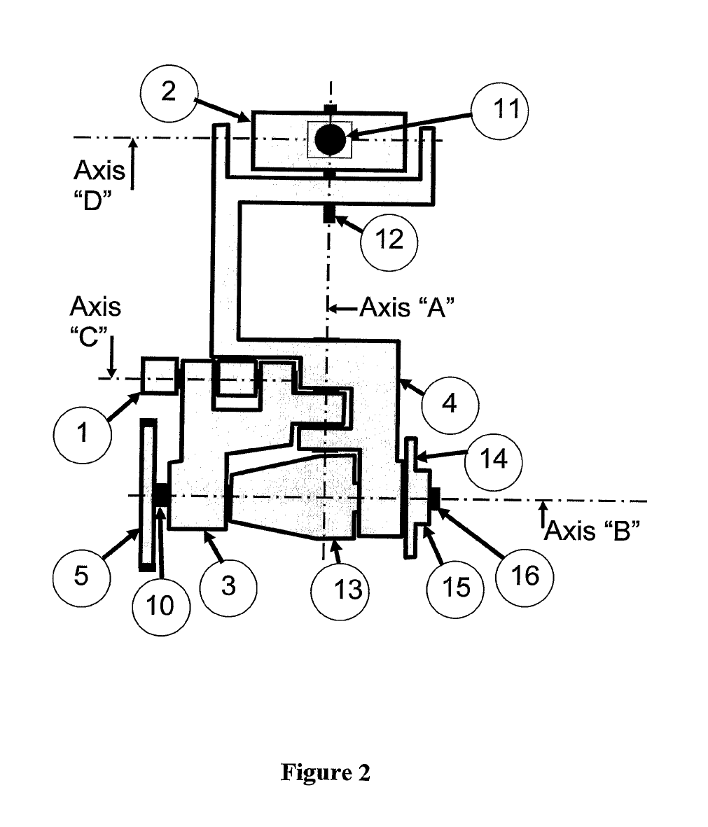

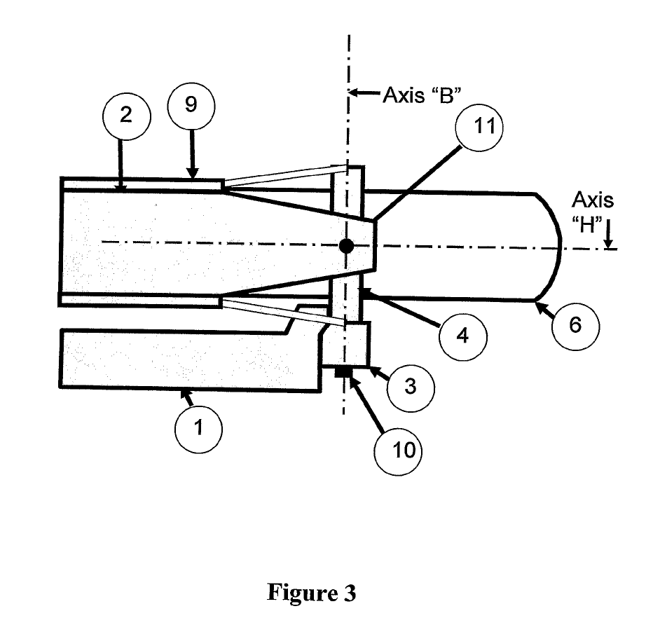

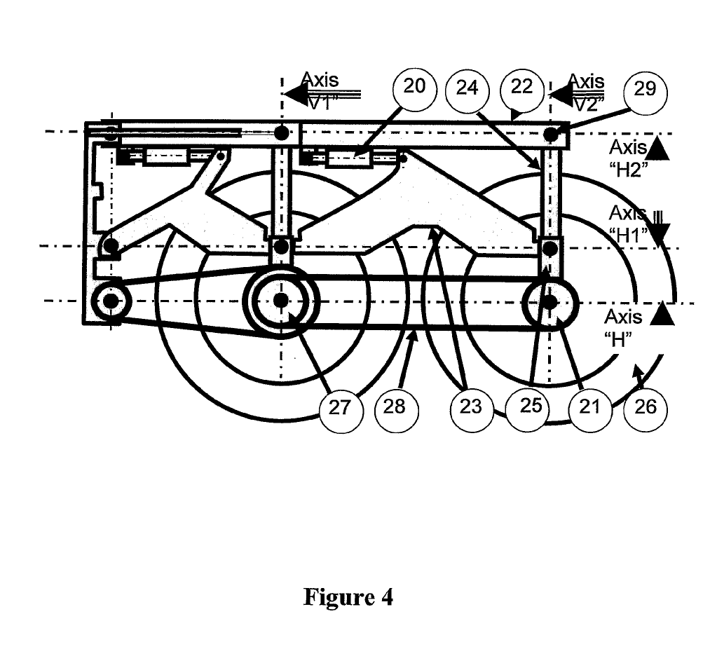

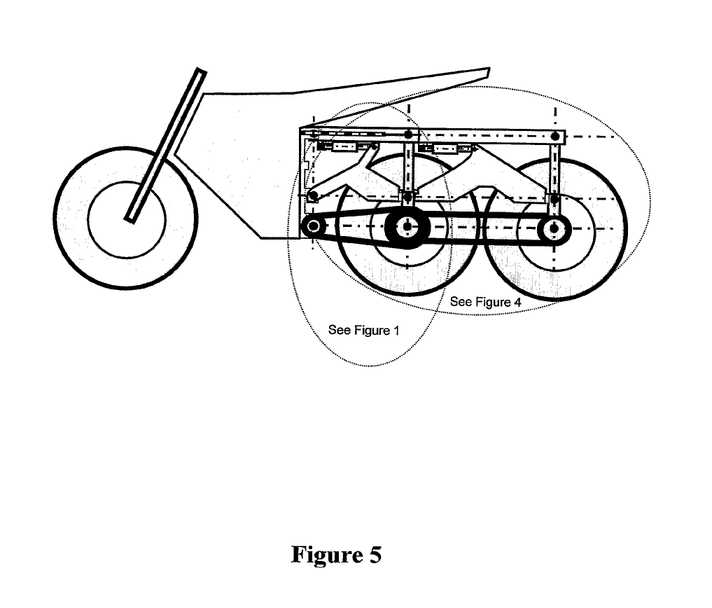

FIG. 4 shows a view on the side of the vehicle upper and lower swinging arms suspension arrangement where the vehicle has two wheels connected in a line e.g. a motorcycle with two rear wheels. Referring to this supplementary suspension arrangement the front part is similar to the arrangement shown in FIG. 1 to control one wheel with the other wheel controlled in a similar fashion by another pair of swinging arms.

In addition to the items described in FIGS. 1 to 3 are a lower swinging arm 23, an upper swinging arm 22, a wheel axle/drive sprocket support strut 24 and 25, a spring damper 20, a wheel 26, a wheel drive sprocket 21, a sprocket driven from the mid wheel 27, a chain 28, pivot points e.g. 29. For the wheel where steering is not required items 24 and 25 can be a single part. The spring damper 20 is mounted between the swinging arms. An alternative position for the spring damper is between the lower swinging arm and the frame.

FIG. 5 shows the arrangement for an in-line three wheel motorcycle. Referring to this three wheel arrangement the front part is similar to a conventional motorcycle with a front wheel and suspension forks, with and engine mounted in a frame and with the arrangement as shown in FIG. 4 attached to the rear of the frame.

1. A multi wheeled single track vehicle comprising of two, three or more wheels in a line, where location of the wheels is provided for each wheel by a pair of equal, or near equal length of swinging arms, one above the other, (upper swinging arm and lower swinging arm) where both arms are positioned with the wheel end pivot axis above the wheel axle, and the motorcycle frame pivot axis above the final drive engine sprocket's rotational axis.

2. A multi wheeled single track vehicle as claimed in claim 1 wherein two or more of the wheels are driven by a transmission comprising a chain and sprocket for drive from the engine to one wheel and another chain and sprocket for drive from one wheel to another, where the swinging arm pair allows the wheel moves up and down following the same or similar arc to an arc to that traced out from the engine drive sprocket axis to the wheel drive sprocket axis.

3. A multi wheeled single track vehicle as claimed in claim 1 wherein two or more wheels are steered by an amount to enable the vehicle to follow a single track, where one of the wheels is not steered while the other wheels are steered and if the rear wheel is steered the turning direction is in reverse to the front wheel, i.e. the rear counter steers to the front, with steering control achieved by a rod and/or cable/or hydraulic/or electric mechanism connected at one end to the handlebar or other part of the front steering system, which provides a push and/or pulling action on the wheel bearing housing steering strut to steer the wheels.

4-7. (canceled)

8. A multi wheeled single track vehicle as claimed in claim 1 wherein one end of the upper swinging arm and lower swinging arm are mounted by pivot joints on the frame and can pivot up and down whilst being restrained from lateral or torsional movement and at the other end (wheel end) the swinging arms are joined by an axial and thrust load bearings to the sprocket drive bearing housing and wheel bearing housing steering strut which act together as a steering strut keeping the upper and lower swinging arm and wheel axle positioned for suspension and steering movement and, allowing the wheel bearing housing to steer about the steering axis.

9-12. (canceled)

13. A multi wheeled single track vehicle as claimed in claim 1 wherein the spherical bearing and wheel bearing housing steering strut to sprocket bearing housing pivot are on the steering axis which in turn is in the mid vertical plane of the motorcycle and wheel and the upper and lower swinging arms move about the frame in a parallelogram shape, this allows the wheel to move up and down whilst maintaining a constants steering caster angle.

14-16. (canceled)

17. A multi wheeled single track vehicle as claimed in claim 1 wherein the chain drive sprocket is mounted on a drive shaft which can rotate in bearings in the sprocket drive bearing housing which is supported by a sprocket support strut with pivot points for a swinging arm and steering pivot and where steering is needed the wheel is mounted on a separate drive shaft which can rotate in bearings in the wheel bearing housing steering strut and the chain drive sprocket drive shaft and wheel drive shaft are connected by a Constant Velocity (CV) joint which is positioned on the wheel steering axis on the vehicle centre line.

18-19. (canceled)

20. A multi wheeled single track vehicle as claimed in claim 1 wherein the suspension, movement of the wheels is controlled by the upper swinging arm, lower swinging arm, wheel axle/drive sprocket support strut and a spring damper (shock absorber) positioned between these swinging arms and the wheel axle is located on the wheel support strut rather than directly on the swinging arm and both of the swinging arms are at one end attached to the motorcycle frame by pivot joints and at their other end attached to the wheel axle support strut by pivot joints.

21-22. (canceled)

23. A multi wheeled single track vehicle as claimed in claim 1 wherein the length between the axis of the pivot joints at the ends of one swinging arm is the same or nearly the same as the length between the axis of the pivot joints at the ends of the other swinging arm, which is in turn the same or nearly the same as the distance between the engine drive sprocket's rotational axis and the wheel drive sprocket's rotational axis, the distance between the two swinging arms' pivot axis on the motorcycle frame is the same or nearly the same as the distance between the two swinging arms' pivot axis on the wheel axle/drive sprocket support strut, the distance between the lower swinging arm's pivot axis on the wheel axle/drive sprocket support strut to the wheel drive sprocket's rotational axis is the same or nearly the same as the distance between the lower swinging arm's pivot axis on the motorcycle frame to the engine drive sprocket's rotational axis.

24-26. (canceled)

27. A multi wheeled single track vehicle as claimed in claim 1 wherein the lower swinging arm is above the chain making it unnecessary for a separate chain guard.

28. A multi wheeled single track vehicle as claimed in claim 1 wherein the lower swinging arm's side member is set to at an angle to the line between each end pivot points as it passes the wheel tyre, with an “̂” shape in the lower swinging arm.

29. A multi wheeled single track vehicle as claimed in claim 1 wherein the lower swinging arm has a suspension spring damper mounting point at the top of “̂” shape positioned at or near the motorcycle vertical axis and the upper swinging arm has a lug close to the pivot point allowing the spring damper to be mounted in a near horizontal position between the upper and lower swinging arm.

30-32. (canceled)

33. A multi wheeled single track vehicle as claimed in claim 1 wherein the upper and/or lower swinging arms may be positioned to one side of the wheel, or made with a fork to be positioned with the wheel between the sides of the swinging arm fork and the swinging arms may be between wheels, with separate support steering struts for each wheel and pairs of swinging arms complete with spring damper and wheel support steering strut can be used for front or rear wheels, or to connect one wheel to another for applications where two or more wheels are connected in a line.

34-35. (canceled)

36. A multi wheeled single track vehicle as claimed in claim 1 wherein the wheel may be braked with a brake calliper fixed to the wheel bearing housing steering strut and provision is made for individual wheels to be braked by their own brakes, alternatively a single brake can be used on one wheel, where the chain transmission provides braking for the other wheels.

37. (canceled)

38. A multi wheeled single track vehicle as claimed in claim 1 wherein an engine, or engines, to propel the vehicle may be located between the front and second wheel, above or to the side of the second or in one or more of the wheels and any of the wheels has combined steering, suspension, brake, drive from a power unit to it and drive from it to the rear wheel and the steering and suspension for the front wheel may be similar to the other wheels and may be driven, or follow the conventional motorcycle telescopic fork steering suspension arrangement without drive and the steering of any of the steered wheels may be by wheel hub steering or other available steering mechanisms.

39. (canceled)

40. A multi wheeled single track vehicle as claimed in claim 1 wherein swinging arms connect two wheels together in a line and each wheel is able to move up and down independently to the others and damper (shock absorber) is mounted horizontal in series and suspension linkages can be repositioned to allow changes in the rate of spring compression for any of the wheels.

41-42. (canceled)

43. A multi wheeled single track vehicle substantially as described herein with reference to FIGS. 1, 2, 3, 4 and 5 of the accompanying drawings.
